(19) United States
(12) Patent Application Publication
(10) Pub. No.: US 2009/0047837 A1
(43) Pub. Date: Feb. 19, 2009

(54) Multiple Slot Terminal

(75) Inventors: Todd Peterson, New Boston, MI (US); Ramon Jaramillo, Sterling Heights, MI (US); Ketan Adhvaryu, Sterling Heights, MI (US)

Correspondence Address: WARN, HOFFMANN, MILLER & LALONE, .P.C, PO BOX 70098, ROCHESTER HILLS, MI, 48307, US

(73) Assignee: BorgWarner Inc., Auburn Hills, MI (US)

(21) Appl. No.: 12/087,613

(22) PCT Filed: Feb. 8, 2007
(86) PCT No.: PCT/US2007/003361

§ 371 Date: Jul. 10, 2008

Related U.S. Application Data
(60) Provisional application No. 60/771,319, filed on Feb. 8, 2006.

(51) Int. Cl. H01R 25/00

(52) U.S. Cl. 439/638

(57) ABSTRACT

The present invention is directed to a dual terminal having first contact portion with an aperture formed through the first contact portion. A second contact portion, similar to the first contact portion and also has an aperture formed through the second contact portion and is arranged so that the aperture of the first contact portion and the aperture of the second contact portion are aligned. The dual terminal also has a circuit connector portion that is disposed between the first contact portion and the second contact portion and facilitates the electrical connection to the first contact portion and the second contract portion.

### CROSS-REFERENCE TO RELATED APPLICATIONS

This application claims the benefit of U.S. Provisional Application No. 60/771,319, filed Feb. 8, 2006. The disclosure of the above application is incorporated herein by reference.

### FIELD OF THE INVENTION

The present invention is directed to a dual M-slot terminal design.

### BACKGROUND OF THE INVENTION

M-slots (along with I/H slots) are mechanical connections that are used in the industry for creating an electrical connection. A typical M-slot has a female member (e.g., the M-slot terminal) that is configured for receiving a male terminal, known as a blade terminal. When the blade terminal is inserted into M-slot the electrical connection is complete. The use of the M-slot terminal provides a clean and reliable electrical connection for assembling a circuit, such as a lead frame to a device. M-slots are also ideal because their small design allows for smaller overall package size. An M-slot design does have disadvantages. For example, an M-slot has limited current carrying capacity. M-slot terminals also have a potential for vibration fatigue failures and can be highly sensitive to male terminal true position for assembly. In other words, the male terminal must be properly aligned with the M-slot during assembly in order to ensure that a proper connection is made.

### SUMMARY OF THE INVENTION

The present invention is directed to a dual terminal having a first contact portion with an aperture formed through the first contact portion. There is also a second contact portion, similar to the first contact portion which has an aperture formed through the second contact portion. The first and second contact portions are arranged so that the aperture of the first contact portion and the aperture of the second contact portion are aligned. The dual terminal also has a circuit connector portion that is disposed between the first contact portion and the second contact portion and facilitates the electrical connection to the first contact portion and the second contact portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an overhead plan view of an unfolded dual terminal;

FIG. 2 is an overhead plan view of the first contact portion of the dual terminal; and

FIG. 3 is a side view of the U shaped dual terminal.

### DETAILED DESCRIPTION OF THE PREFERRED EMBODIMENTS

The following description of the preferred embodiment(s) is merely exemplary in nature and is in no way intended to limit the invention, its application, or uses.

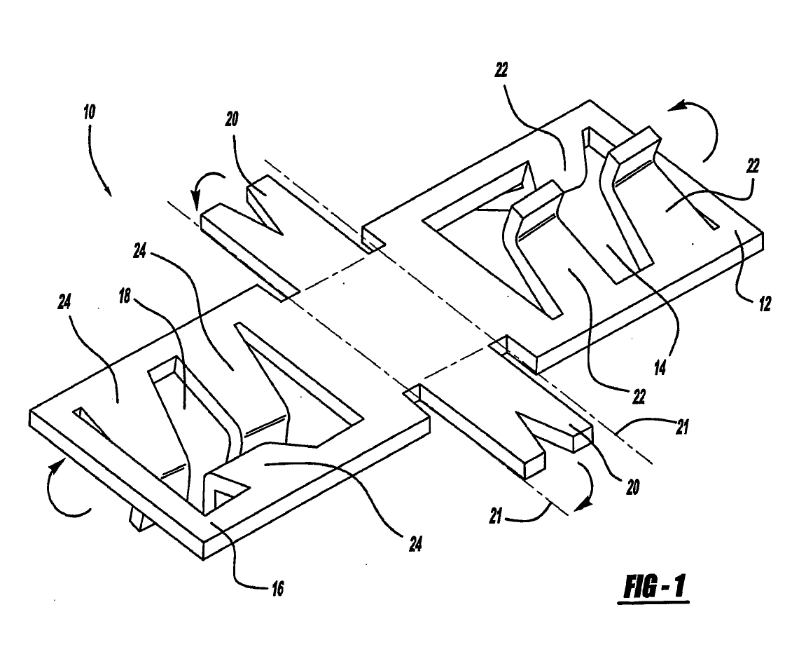

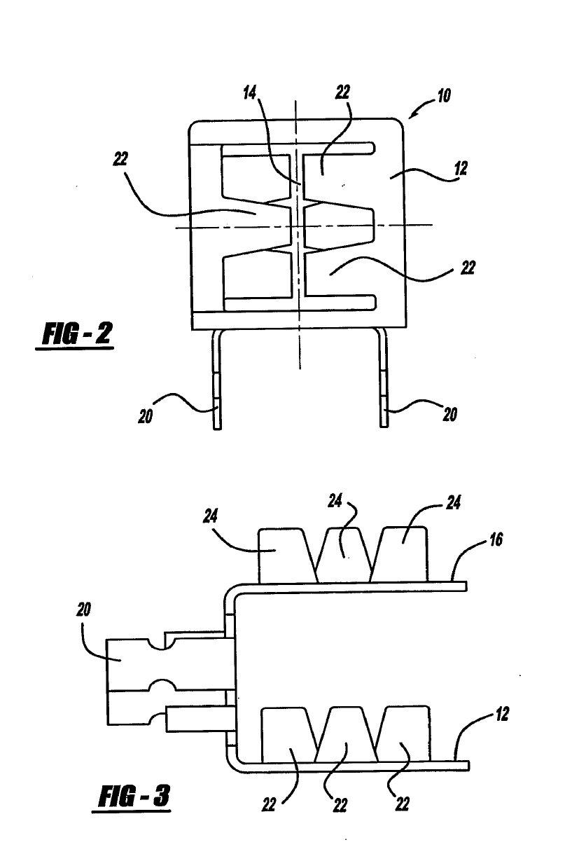

Referring now to FIGS. 1-3 a dual terminal 10 is shown. The dual terminal 10 described herein uses M-Slot terminals, however it is possible to use this design in other terminals that would benefit from an increased contact surface area. The dual terminal 10 can be made from a single metal sheet which is folded to form the dual terminal structure as shown in FIGS. 2 and 3. The dual terminal 10 has a first contact portion 12, which can be an M-Slot or an I/H Slot. The first contact portion 12 has an aperture 14 having flanges 22 extending into the aperture 14 for creating a female portion of the M-Slot terminal. The flanges 22 can be bent to allow the aperture 14 to slidably receive a blade terminal of a device. The flanges 22 are resilient and will hold the blade terminal in position within the aperture 14.

A second contact portion 16 also has an aperture 18 with flanges 24 extending into the aperture 18 also forming a. female portion of the M-Slot. The second contact terminal 16 together with the flanges 24 are configured to slidably receive a blade terminal and the flanges 24 act as resilient members for holding the blade terminal in position.

The first contact portion 12 and second contact portion 16 are aligned so that the apertures 14 and 18 are in alignment. Thus, the blade terminal when connected to the dual terminal 10 will extend through the aperture 14 of the first connector 12 and into the aperture 18 of the second connector 16. This provides twice the amount of contact surface area between the blade terminal and the dual terminal 10 than would normally be provided for a single M-Slot terminal. The greater contact surface area also allows for the blade terminal to be held more tightly to the dual terminal 10. The use of the dual terminal 10 permits a greater amount of current to be processed through the dual terminal 10 since the contact surface area is now roughly two times the contact surface of a single M-Slot design. Also the use of two of the dual terminal 10 design minimizes the possibility of the blade terminal losing its connection due to vibration.

Between the first contact portion 12 and second contact portion 16 is a circuit connector portion 20 that connects the first and second contact portions 12, 16. The circuit connector portion 20 can be soldered to a circuit, such as a lead frame, wire or other suitable medium so that the first and second contact portions 12, 16 can be electrically connected to a circuit. It is also within the scope of this invention for the circuit connector portion 20 to be connected to a circuit through some other means besides soldering, for example, the circuit connector portion 20 could be integrally formed to a lead frame circuit.

The overall shape of the dual terminal 10 once it has been formed, will have a U shape.

The circuit connector portion 20 along with either one or both of the first and second contact portions 12, 16 can be molded into a plastic form. This will help to insulate the first and second contact portions 12, 16 as well as the circuit connector portion 20 from possible short circuits.

In order to form the finished dual terminal 10 shown in FIGS. 2 and 3 the first contact portion and second contact portion are folded about dashed lines 21 in the direction shown by the arrow. The circuit connector portions 20 are folded in the opposite direction of the first and second contact portions 12, 16.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A dual terminal comprising:.
a first contact portion having an aperture formed through said first contact portion;
a second contact portion having an aperture formed through said second contact portion wherein said first contact portion and said second contact portion are positioned so that said aperture of said first contact portion is aligned with said aperture of said second contact portion; and
a circuit connector portion disposed between said first contact portion and said second contact portion wherein said connector portion connects said first contact portion and said second contact portion.

2. The dual terminals of claim 1 wherein said first contact portion and said second portion are M-slot terminals.

3. The dual terminals of claim 1 wherein said dual terminal is arranged in the shape of a U wherein said second contact portion is positioned below said first contact portion in a generally parallel manner and said circuit connector portion extends between said first and second contact portions at a generally perpendicular angle.

4. The dual terminal of claim 1 wherein said dual terminal is formed of a single metal sheet.

5. The dual terminal of claim 1 further comprising a device terminal extending through said aperture of said first contact portion into said aperture of said second contact portion wherein said device terminal is electrically connected to said first contact portion and said second contact portion.

6. The dual terminal of claim 1 wherein said circuit connector portion is soldered. to a lead frame and is held in place by a plastic form.

7. The dual terminal of claim 6 wherein said first portion is held in place by said plastic form.

8. A dual terminal comprising:
a first contact portion having an aperture with two or more flanges positioned in said aperture of said first contact portion to form a clip;
a second contact portion having an aperture with two or more flanges forming a clip within said aperture of said first contact portion, wherein said first contact portion and said second contact portion are positioned so said aperture of said first contact portion is aligned with said aperture of said second contact portion;
a circuit connector portion positioned between and connecting said first contact portion and said second contact portion; and
a blade terminal disposed through said aperture of said first contact member and extending into said aperture of said second contact member, wherein said clip of said first contact portion and said clip of said second contact portion form a contact surface on said blade for facilitating an electrical connection between said dual terminal and said blade terminal.

9. The dual terminal of claim 8 wherein said dual terminal is arranged in the shape of a U wherein said second contact portion is positioned below said first contact portion in a generally parallel manner and said circuit connector portion extends between said first and second contact portions at a generally perpendicular angle.

10. The dual terminal of claim 8 wherein said dual terminal is formed of a single metal sheet.

11. The dual terminal of claim 8 wherein said circuit connector is connected to a lead frame and said circuit connector is held in place by a plastic form which supports said lead frame.

12. The dual terminal of claim 11 wherein said first contact portion is also held in position within said plastic form.
